(19) United States
(12) Patent Application Publication
(10) Pub. No.: US 2026/0322753 A1
(43) Pub. Date: Oct. 15, 2026

(54) Identifying Remote Direct Memory Access Flows Based on Message Semantics

(71) Applicant: Arista Networks, Inc., Santa Clara, CA (US)

(72) Inventors: Thomas Benjamin Emmons, Sunnyvale, CA (US); Devon Joseph McAvoy, Auburn, NH (US); Dileep Ramesh, Sunnyvale, CA (US); Diksha Mahajan, Bengaluru (IN); Satish Kumar Selvaraj, San Jose, CA (US); Ajay Chhatwal, Fremont, CA (US)

(21) Appl. No.: 19/254,507

(22) Filed: Jun. 30, 2025

(30) Foreign Application Priority Data
Apr. 15, 2025 (IN) 202541036314

(51) Int. Cl. H04L 47/2483; G06F 15/173; H04L 45/745

(52) U.S. Cl. CPC H04L 47/2483; G06F 15/17331; H04L 45/745

(57) ABSTRACT

A network device and a method in the network device are disclosed. The network device identifies flows of interest by programming a snoop rule in the TCAM (ternary content addressable memory) of the network device. The snoop rule contains match criteria based on specific data fields within the flow. When a packet matches a snoop rule, it is sent to the CPU. The CPU analyzes the packet to learn the flow and generate a flow-specific rule. The flow-specific rule is programmed in the TCAM and functions to filter subsequent packets belonging to the same flow, which are then processed according to one or more actions defined in the flow-specific rule.

### CROSS REFERENCE TO RELATED APPLICATIONS

Pursuant to 35 U.S.C. § 119(e), this application is entitled to and claims the benefit of the filing date of Indian Provisional App. No. 202541036314, filed Apr. 15, 2025, the content of which is incorporated herein by reference in its entirety for all purposes.

This application is related to:
U.S. application Ser. No. 18/902,521, filed Sep. 30 , 2024, entitled “Systems And Methods For Reducing Congestion In Transmitting Flows Of Communication Collectives”
U.S. App. No. [000200-040800US], filed Jun. 30, 2025, entitled “Identifying Remote Direct Memory Access Flows Based on Message Semantics”
U.S. App. No. [000200-040900US], filed Jun. 30, 2025, entitled “Redirecting Flows for Cluster Load Balancing”
U.S. App. No. [000200-041000US], filed Jun. 30, 2025, entitled “Cluster Load Balancing Using Exact Match Table and Hardware Detection”
   the content of all of which is incorporated herein by reference in their entirety for all purposes.

### BACKGROUND

The present disclosure relates to distributed computing systems and, more particularly, to monitoring and reducing congestion of traffic flows in a distributed computing system.

Applications that utilize processes running on distributed computing systems may exchange data using network protocols designed to facilitate the rapid and reliable transfer of data over the underlying network. These network protocols are all built to make use of Remote Direct Memory Access (RDMA). RDMA is a remote memory transfer technology that enables networked computers (hosts) to exchange data between their respective main memories. For example, RDMA is commonly used to exchange data between the memories of graphics processing units (GPUs) hosted in servers in a network of servers.

RDMA uses a direct memory access (DMA) mechanism to transfer data directly between the respective memories of networked computers with little to no involvement of their respective central processing units (CPUs) or operating systems (OS's) to manage the data transfer, other than to initiate the transfer itself, get notification of transfer completion, and handle any errors.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows an example of a distributed computing network that can accommodate embodiments in accordance with the present disclosure.

FIG. 2 shows an example of a distributed computing network using a leaf-spine communication network.

FIGS. 3A and 3B illustrate an example of Remote Direct Memory Access (RDMA) using RDMA over Converged Ethernet (RoCE v2).

FIGS. 4 and 5 illustrate an example of operations to learn flows in accordance with the present disclosure.

FIGS. 6 and 7 illustrate an example of operations to redirect flows in accordance with an embodiment of the present disclosure, including processing learned flows one at a time.

FIGS. 8A and 8B illustrate a sequence example of operations to redirect flows in accordance with the present disclosure.

FIG. 9 illustrates an example of operations to redirect flows in accordance with another embodiment of the present disclosure, including processing learned flows in batches.

FIG. 10 illustrates a generalized example of a network device.

### DETAILED DESCRIPTION

RDMA is typically implemented in the respective network interface cards (NICs) of the computers. For example, two networked computers can each be configured with a NIC that supports RDMA, enabling the NICs to exchange data with each other. Each NIC in a computer has DMA capability to read from and write to the computer's memory, thus bypassing the memory management functions of the OS.

Standardized implementations of RDMA include:
RDMA over Converged Ethernet (RoCE)—RoCE is a network protocol that enables RDMA communications over an Ethernet. RoCE v1 is a version of the protocol that operates at the Ethernet link layer. RoCE v2 is a version of the protocol that operates at the Internet layer, allowing for routing and communication across different networks.
Internet Wide Area RDMA Protocol (iWARP)—iWARP is an RDMA implementation that uses Transmission Control Protocol (TCP) or Stream Control Transmission Protocol (SCTP) to transmit data.
InfiniBand—InfiniBand is a communications network standard that can provide native support for RDMA in a NIC.
Ultra Ethernet Transport (UET)—UET is a transport protocol enabling RDMA over IP packets. UET features updated congestion control and network multipathing.

RDMA is useful in applications that benefit from high speed transfer of large blocks of data. Use cases include, but are not limited to, applications such as:
scientific and engineering computations, for example, modeling biological systems, weather modeling, stress analysis, fluid dynamics, and the like,
financial services,
artificial intelligence/machine learning (AI/ML), and
storage solutions.

Briefly, RDMA transfers a block of data from one computer to another computer in units of data called “messages.” The data in a message is transmitted in a stream of packets (i.e., a message comprises a stream of packets), where the number of packets in a message depends on factors such as the amount of data in the message, the size of each packet, the underlying protocol, and so on. In some instances, RDMA may break up a sufficiently large block of data into multiple messages. At the application level, RDMA transfers can be invoked by library calls made between applications running on different CPUs; e.g., copy, read, write, etc.

In order to improve throughput in a RoCE v2 deployment, the network that interconnects the computers (hosts) in a distributed computing system can implement multi-pathing mechanisms to distribute (balance) the traffic load more evenly across the network. Flows of messages between two computers in the network can be directed to their respective destinations by distributing (or “hashing”) the flows across multiple shared links within a network according to a function that mixes or “hashes” a subset of the flow's fixed header fields so as to choose a next hop (static hashing). In some use cases, a default load balancing mechanism may take each flow and attempt to spread it across all viable paths in the network. In this latter approach, packets from a single flow are forwarded so as to use all viable paths from the source to the destination.

Load balancing by hashing flows can result in lower performance than using the all paths approach. The all-paths approach utilizes all viable paths to forward packets on a given flow to the destination, and thus can achieve even utilization of the network. The all-paths approach, however, requires specific support in the NIC hardware for both the sender (source) and the receiver (destination). Without this support, the all-paths approach cannot be successfully implemented. Moreover, the all-paths approach may necessitate special purpose logic in both the sender NIC and the receiver NIC, as well as cost for additional memory and processing capabilities in the NIC hardware. In some implementations, cost can be reduced by tolerating only a limited amount of reordering, but at the cost of reduced performance.

Other approaches use dynamic load balancing (DLB), which involves choosing a path for a flow by taking into account local knowledge of the utilization on immediately-connected links for each viable path. In DLB, a newly seen flow is assigned to take a path on the least congested, or an under-utilized, next hop link. However, since only information about utilization of the next hop links is used, DLB cannot account for congestion in subsequent links on the path, and so DLB cannot ensure good performance for all flows.

An aspect of the present disclosure is learning flows in a network device, including:
1. programming the network device with a snoop rule to snoop (listen) for a “begin” packet;
2. filtering received network traffic;
3. detecting the begin packet of a message in the received traffic via the snoop rule;
4. identifying the flow from the snooped packet; and
5. processing (monitoring/detecting) subsequently received traffic that belongs to the identified flow.

Another aspect of the present disclosure is redirecting flows in a distributed computing system to balance the flow of traffic among network devices in the distributed computing system. Each network device in the distributed computing system:
1. receives traffic from hosts connected to the network device;

2. learns of a new RoCE v2 flow; and
3. programs one or more of its forwarding tables to specifically detect and explicitly direct packets in the new flow to a specific next hop.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

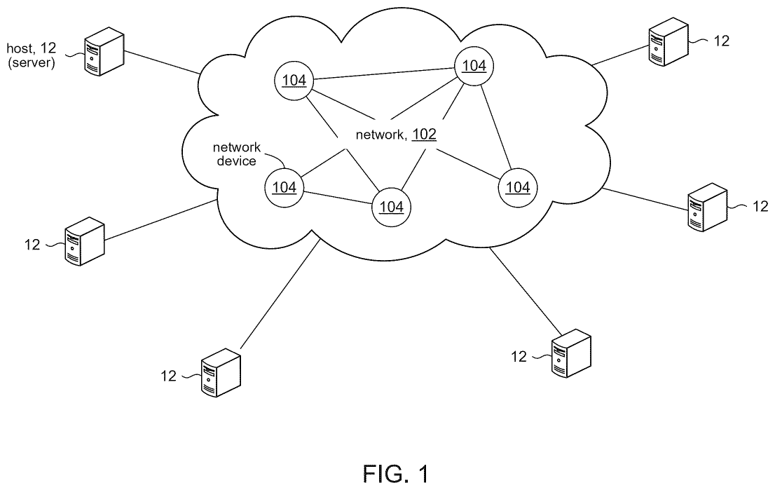

FIG. 1 is a high-level generalized representation of a distributed computing system 100 suitable for implementing the techniques in accordance with the present disclosure. In some embodiments, distributed computing system 100 includes a network 102 connecting multiple hosts 12. Network 102 comprises interconnected network devices 104, such as switches, routers, and edge devices, and the like to enable communication between the connected hosts 12. Network devices 104 can be arranged using various distributed network architectures, including Clos networks (e.g., 3-stage, 2-stage), dragonfly networks, and full or partial mesh topologies.

Computing system 100 is a “distributed” computing system in that hosts 12 are interconnected by network 102 and collaborate to handle complex computational tasks. This collaboration involves dividing a given task into smaller work units, which are then distributed across the hosts. Hosts 12 communicate among themselves to exchange data, results, and information, enabling them to collectively address the task.

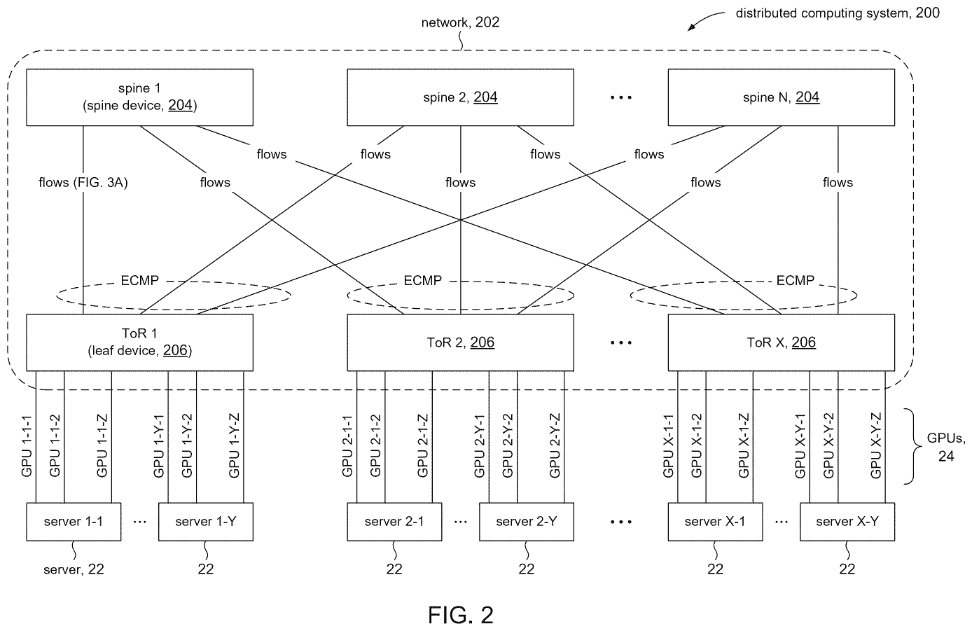

FIG. 2 illustrates an example of a distributed computing system 200, comprising network 202 and servers (hosts) 22 connected to the network. For the purposes of explaining various aspects of the present disclosure, a leaf-spine topology will be used as an illustrative example of network 202, with the understanding that embodiments of a distributed computing system in accordance with the present disclosure can use any suitable network topology. Network 202 comprise network devices, including spine devices (nodes) 204 and leaf devices (nodes) 206. The figure shows a number (N) of spine devices 204 and a number (X) of leaf devices 206 (also referred to as ToRs, top-of-rack devices). Each leaf 206 (e.g., ToR 1) connects to each spine device 204, spine 1, spine 2, . . . spine N. For discussion purpose, the connection between a spine and leaf can comprise a single physical link, although it will be appreciated that in other embodiments, a connection between a given leaf (e.g., ToR 1) and a given spine (e.g., spine 1) can comprise more than one physical link. Each leaf device 206 has a number (Y) of servers 22 connected to it. In general, it will be appreciated that in other embodiments the number of servers connected to a leaf device 206 can vary from one leaf device to another.

Each server 22 hosts a number (Z) of independently running compute units 24, which in some embodiments are GPUs (graphics processing units). It will be appreciated that in other embodiments, the number of GPUs in a server 22 can vary from one server to another. Although not illustrated in FIG. 2, each server 22 includes one or more NICs (network interface cards) providing an interface between GPUs 24 in the server and the leaf device 206 to which the server is connected. Although the present disclosure describes compute units 24 as GPUs, it will be appreciated that in other embodiments, the compute units can be other kinds of processing units such as CPUs (central processing units), FPGAs (field programmable gate arrays), ASICs (application specific ICs), accelerators, etc. In some embodiments, compute units 24 can comprise a mixture of different processing units.

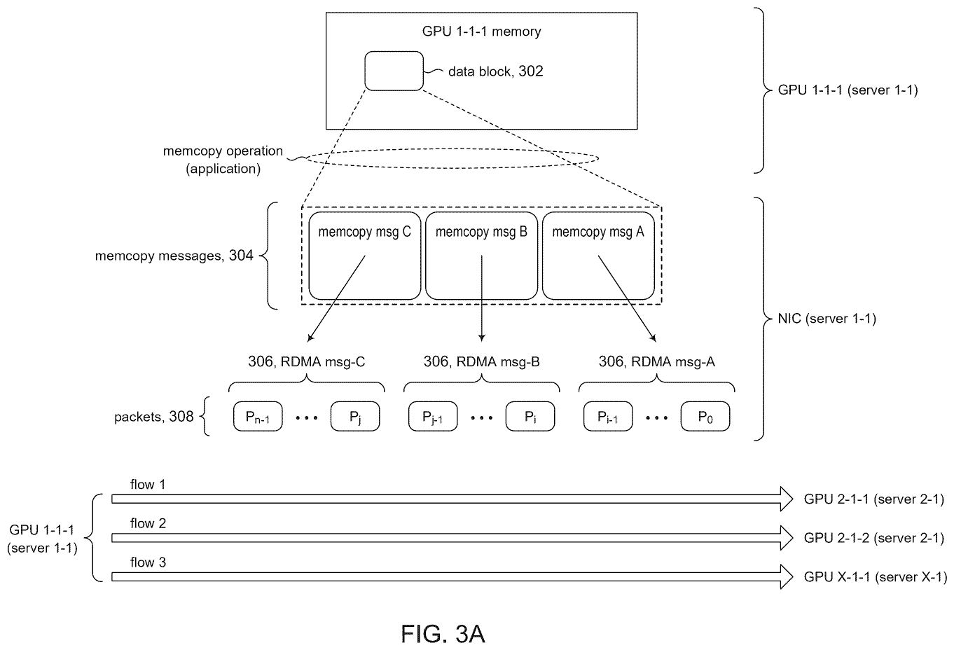

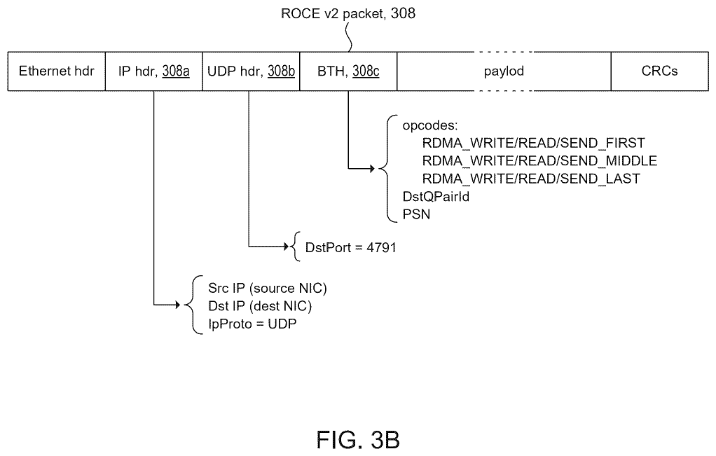

FIGS. 3A and 3B illustrate an example of RDMA. As explained, a computational task can be divided into smaller tasks that are then distributed across multiple GPUs 24 in one or more servers 22 in the distributed computing system 200. Distributing a computational task between GPUs can involve the movement of large amounts of data across GPUs. For example, in the area of machine learning, training a large language model involves computations where significant amounts of data are moved and processed to adjust (train) the parameters of the data model. When the GPUs performing the task are on servers connected to different leaf devices 206, this can involve moving large amounts of data over the network 202. As such, processes involved in machine learning training utilize network protocols and/or hardware designed to facilitate the rapid and reliable transfer of data over networks. As noted above, one such network protocol is Remote Direct Memory Access (RDMA) over Converged Ethernet, version 2 (RoCE v2).

RDMA is a remote memory management capability that allows data movement directly between the memories on different GPUs without involving the processing components of the GPUs themselves. RoCE allows RDMA over an Ethernet network. Since RoCE enables direct access to a GPU's memory via a network interface (e.g., rather than through the kernel), RoCE can provide low-latency and high-performance transmission. While RoCE v1 is an Ethernet link layer protocol, RoCE v2 utilizes the User Datagram Protocol (UDP) (e.g., using Internet Protocol (IP) and UDP headers and a particular UDP destination port value), and thus RoCE v2 packets may be routed. Merely for the purposes of the present disclosure, embodiments disclosed herein are described using RoCE v2 as an example. It will be appreciated, however, that embodiments in accordance with the present disclosure can be adapted to RoCE based messaging other than RoCE v2, and in general can be adapted to any suitable messaging protocols for RDMA.

The RoCE v2 protocol is understood. Briefly, a first application instance running on a GPU on one server (e.g., GPU 1-1-1 on server 1-1, FIG. 2) can perform a memory transfer operation (e.g., a write operation such a “memcopy”) to transfer a block of data stored in its memory to another GPU on another server (e.g., GPU 2-1-1 on server 2-1) using RoCE v2. Depending on the size of the block of data, the memory transfer operation may transfer the block of data in a single unit referred to in RDMA as a “message,” or the memory transfer operation may partition the block of data into several RDMA messages.

FIG. 3A shows an example of an application running in GPU 1-1-1 and transmitting data block 302 to GPU 2-1-1. The application can invoke a memcopy operation, which interacts with a NIC on server 1-1 (or on the GPU itself) to transfer the data. The NIC can directly access the memory of GPU 1-1-1 without having to make system calls into an OS (not shown) running on the server or involving the host CPU. Depending on the size of the data block, the memcopy operation can send data block 302 in a single memcopy message 304 to the NIC, or the memcopy operation can send the data block in several memcopy messages. FIG. 3A shows an example where the memcopy operation partitions data block 302 into three memcopy messages 304, msg A, msg B, msg C. The NIC processes each memcopy message 304 to generate a corresponding RDMA message 306 comprising a set of packets 308 that contain the data in the memcopy message.

Each packet 308, in turn, includes a source IP of the NIC on server 1-1, a destination IP of the NIC on server 2-1, and a QPairId that identifies a work queue on GPU 2-1-1. Each packet includes a monotonically increasing packet sequence number (PSN) that represents an ordering of the data in data block 302.

A flow generally refers to a stream of packets between two endpoints in a network. In some situations, a flow can be a unidirectional stream. For example a stream of packets in the direction from endpoint A to endpoint B can be considered one flow and a stream of packets in the direction from endpoint B to endpoint A would be another flow.

The two endpoints of a flow in accordance with the present disclosure are (1) the source NIC and (2) the destination NIC/QPairId on the destination GPU. The set of messages 306 on a flow can be identified using the source IP, destination IP, and QPairId (destination work queue) in their constituent packets 308. The example in FIG. 3A shows three different flows: flow 1 refers to a data stream from GPU 1-1-1 to a QPairId on GPU 2-1-1; flow 2 refers to a data stream from GPU 1-1-1 to a QPairId on GPU 2-1-2 (on the same server as GPU 2-1-1); flow 3 refers to a data stream from GPU 1-1-1 to a QPairId on GPU X-1-1 on server X-1.

The example in FIG. 3A shows only three RDMA messages 306 arising from the memcopy operation of data block 302. However, while performing a computing job (e.g., training a model, simulation, etc.), there can be many transfers (memcopy operations) of very large amounts of data among the GPUs. Accordingly, a flow between any two GPUs (e.g., GPU 1-1-1 and GPU 2-2-1) may carry many RDMA messages related to a given memcopy operation. Similarly, the flow can also carry groups of RDMA messages arising from several memcopy operations.

As noted above, in RoCE v2 data transfers occur in units of messages that are demarcated or otherwise delineated using a write first (beginning-of-message) packet and a write last packet, with one or more write middle packets between the write first and write last packets. It will be noted, however, that the present disclosure can be practiced using other data transfer protocols or hardware where the start and the end of a data transfer is similarly delineated (e.g., in the data transfer itself, such as in a packet associated with the data transfer) such as, for example, InfiniBand or Ultra Ethernet Consortium's Ultra Ethernet Transport (UET).

FIG. 3B is a high-level representation of a RoCE v2 packet 308 in a message 306. Packet 308 comprising the following fields:
Ethernet header: Includes the source and destination MAC addresses; e.g., of the source and destination NICs, respectively.
IP header, 308a: Includes the source and destination IP addresses (e.g., of the source and destination NICs, respectively), and prototype=UDP to indicate the IP packet encapsulates a UDP protocol.
UDP header, 308b: Includes the source and destination port numbers. The UDP destination port is 4791 for RoCE v2.
Base Transport Header (BTH), 308c: This element is described below.
Payload: The actual data being transmitted. The payload comprises a message 304.
CRC: One or more check codes for data integrity.

BTH opcode—Each packet 308 in a message 306 includes an opcode. For example, the first packet (e.g., P₀, Pᵢ, Pⱼ) in a message can be marked with a beginning-of-message opcode, the last packet (e.g., Pᵢ₋₁, Pⱼ₋₁, Pₙ) in a message can marked with an end-of-message opcode. For example, a Write type of message uses RDMA_WRITE_FIRST and RDMA_WRITE_LAST as the opcodes to delimit the message. Packets in the middle of a Write message have a RDMA_WRITE_MIDDLE opcode. Likewise a Read type of message uses the opcodes RDMA_READ_FIRST and RDMA_READ_LAST to delimit the message, and a Send type of message use the RDMA_SEND_FIRST and RDMA_SEND_LAST opcodes. Packets in the middle of a Read message have a RDMA_READ_MIDDLE opcode.

BTH destination queue pair (DstQPairId)—This is a number that identifies a work queue on the destination GPU.

BTH packet sequence number (PSN)—This is a monotonically increasing number across packets of a memory transfer operation. The PSN enables the destination to reorder packets correctly if packets arrive out of order; e.g., due to network congestion or other factors.

### Learning Flows

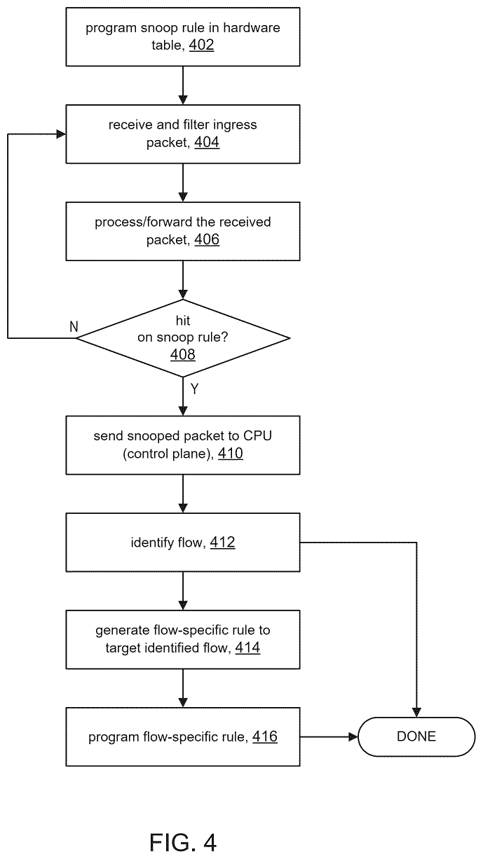

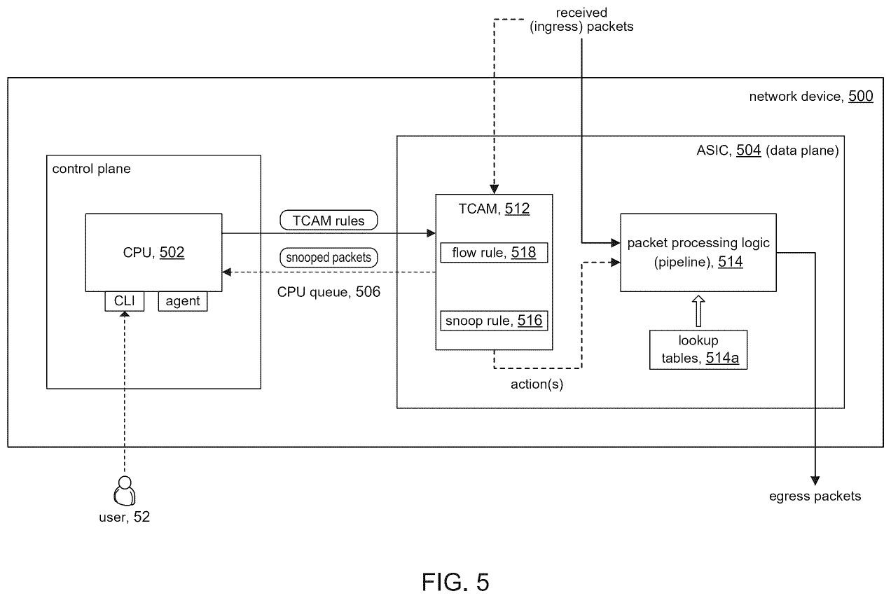

An aspect of the present disclosure is learning flows. Existing technology for learning flows in a network is to sample packets to the CPU. Because the CPU cannot handle nearly as many packets as traverse through the network device, this sampling is performed at a rate 1/n so as not to tax the CPU processing bandwidth, where n is commonly on the order of 1000 or 10000. As such, when a new flow enters the network, on average n packets of that flow must be sampled in order to learn the flow. Conventional sampling can take a substantially longer time in certain cases. The proposed method shown in FIGS. 4 and 5 learns flows more quickly than conventional sampling techniques.

FIGS. 4 and 5 illustrate a high-level example of processing packets in a network device (e.g., 104, FIG. 1, spine device 204, leaf device 206, FIG. 2) to learn flows in accordance with the present disclosure. The processing is divided between the control plane and the data plane. In some embodiments, the network device can include one or more processing units (circuits), which when operated, can cause the network device to perform processing in accordance with FIG. 4. Processing units (circuits) in the control plane, for example, can include general CPUs that operate by way of executing computer program code stored on a non-volatile computer readable storage medium (e.g., read-only memory); e.g., CPU 502 (FIG. 5) in the control plane can be a general CPU. Processing units (circuits) in the data plane can include specialized processors such as digital signal processors, field programmable gate arrays, application specific integrated circuits (ASICs), and the like, that operate by way of executing computer program code or by way of logic circuits being configured for specific operations; e.g., switching ASIC 504 in the data plane.

At operation 402, the network device (control plane) can program a snoop (learning) rule 516 to learn flows in accordance with the present disclosure. In some embodiments, for example, the snoop rule can be programmed in a hardware forwarding table of the network device; e.g., a TCAM (ternary content addressable memory, 512). In some embodiments, for example, a snoop rule can be programmed and/or revised by user 52 via a suitable CLI (command line interface) on the network device.

Using RoCE v2 packets as an example, the snoop rule can match on RoCE v2 packets and more specifically RoCE v2 packets that indicate the beginning of a message. In some embodiments, the match criteria for a snoop rule can match on the following data fields to identify a beginning-of-message packet:
IpType—The match criteria can match on this data field to look for IPv4 or IPv6 packets.
IpProto—RoCE v2 is encapsulated in a UDP payload. Accordingly, the match criteria can match on this data field to identify packets that encapsulate UDP.
L4DstPort—RoCE v2 uses a destination port number of 4791. Accordingly, the match criteria can match on this data field having the value 4791.
BTH opcode—As described above, the beginning of an RoCE v2 message is indicated by the first packet in the message having one of the beginning-of-message opcodes listed above. The match criteria can match on this data field to contain one such opcode, for example RDMA_WRITE_FIRST, RDMA_READ_FIRST, or RDMA_SEND_FIRST. More generally however, in other embodiments, the snoop rule can match on other data field(s) that indicate the packet is the first packet in a message.

The above match criteria will match RoCE v2 packets that are on a local flow or a remote flow. A local flow refers to a flow between servers connected to the same network device. Referring to FIG. 2, for example, a flow from server 2-1 to server 2-Y represents a local flow because both servers are connected to the same leaf device, namely ToR 2; server 2-Y is local relative to server 2-1. Likewise, a flow between GPU 2-1-1 to GPU 2-1-2 represents a local flow because both GPUs are on ToR 2. On the other hand, a flow from server 1-1 on ToR 1 to server 2-Y on ToR 2 represents a remote flow because the servers are on different ToRs (network devices); i.e., server 2-Y is remote relative to server 1-1.

The snoop rule above snoops RoCE v2 packets in local and remote traffic. In some embodiments, for a given use case, it may be desirable to snoop only on remote traffic. In such embodiments, the snoop rule can include additional match criteria to match specifically for packets in remote traffic. In some embodiments, to look for remote traffic, the match criteria can match on information such as:
DstClassL2—In the case of a bridged VxLAN (virtual extensible local area network) configuration, this data field is used to match on packets that egress with a VxLAN encapsulation by matching on the ClassId of the remote MAC.
DstL3EgressNextHop—In the case of routed forwarding, in some embodiments, the egress nexthop can be encoded so that all equal cost multi-path (ECMP) groups have bit 0x8000 set. Because local servers are not reached via an ECMP group, matching on only this bit in this data field will allow filtering of only remote flows.
FecId—In the case of ECMP-based forwarding, for example, ECMP FECs can be between 0x0000 and 0x10000. Because local servers are not reached via an ECMP group, matching on only this bit in this data field will allow filtering of only remote flows.

In the case of encapsulated flows, e.g., tunneled flows such as VxLAN tunnels, the data fields (e.g., header information) for identifying a beginning-of-message packet will occur in different locations within the packet depending on the particular encapsulation. As shown in FIG. 3B, for example, RoCE v2 packets may be encapsulated as follows:

Eth-IP-UDP-BTH-payload

In the case of a tunnel, e.g., where RoCE v2 packets are VxLAN-encapsulated, the encapsulation looks like:

Eth-IPv4-UDP-VxLAN-Eth(inner)-IPv4(inner)-UDP-BTH-payload

where the BTH header is located further in the packet. It will be appreciated that the match criteria in the snoop rule can be specified accordingly to accommodate the different encapsulations.

At operation 404, the network device (data plane) receives and filters packets (network traffic). For example, the network traffic can be filtered by applying rules stored in TCAM 512 where received packets in the network traffic are input to the TCAM to match against the rules stored in the TCAM. Generally, a TCAM matches data fields in the received packet against match criteria of rules programmed in the TCAM, including the snoop rule. The TCAM outputs the highest priority rule that is matched, if any. More particularly, the TCAM will output actions associated with the highest priority matched rule.

At operation 406, the network device (data plane) can provide the received packet to a packet processing pipeline (e.g., 514). The packet processing pipeline can process the received packet according to lookup tables (e.g., 514a) to rewrite the received packet for egress; e.g., identifying a next hop, encapsulating the packet, changing data fields in the packet, updating packet metadata (e.g., counters) associated with the packet, dropping the packet, and so on. Processing in the pipeline can also be controlled by action(s) associated with a matched rule (if any) from the TCAM.

At decision point 408 (data plane), if the snoop rule did not match the received packet, the received packet requires no further processing. The network device returns to operation 504 to resume receiving traffic. On the other hand, if the received packet matched (hit) on the snoop rule, then the received packet is snooped and sent (operation 410) to the CPU for further processing. In some embodiments, for example, the snoop rule can include an action that causes the network device to forward the snooped packet to the CPU. For example, the snooped packet can be enqueued on a (CPU) queue 506 that the CPU can read. An agent running on the CPU can process snooped packets enqueued on the CPU queue.

At operation 412, the agent running on the CPU can determine the flow key that identifies the flow of the snooped packet using information in the snooped packet. In the case of RoCE v2 packets, for example, the flow key can be a 3-tuple comprising the source and destination IP addresses in the IP header portion of the snooped packet and the destination QPairId in the BTH header (FIG. 3B) of the snooped packet.

At operation 414, the agent running on the CPU can generate a flow-specific rule 518 to target the identified flow and to take action on the identified flow. The flow-specific rule comprises a match component and an action component. The match component can include criteria to match the flow. The following match criteria (flow key) can be obtained from the received packet:
IpProto==UDP to look for UDP packets
L4DstPort==4791 to look for RoCE v2 type UDP packets
DstIP==IP (v4 or v6) address of destination IP contained the received packet
QPairId==DstQPairId (FIG. 3B) contained in the BTH header in the received packet
   As noted above, in the case of encapsulated flows, e.g., tunneled flows such as VxLAN tunnels, the data fields (e.g., headers) for a flow will occur in different locations within the packet depending on the particular encapsulation. It will be appreciated that the match criteria in the redirect rule can be specified accordingly to look for these data fields depending on the different encapsulations.

The action component for the flow-specific rule can include any suitable action or actions, and will depend on the specific use case. Typical use cases include, but are not limited to:
network traffic analysis: understanding overall network utilization and identify bottlenecks;
security threat detection: identifying malicious activity such as DDOS attacks, malware infections, and the like;
regulatory compliance: auditing network activity and ensuring compliance with data protection regulations;
network planning and optimization: designing and optimizing networks.
   The action component can include actions such as:
mirroring the matched packets to capture a flow;
incrementing a counter to monitor the number of packets in a flow;
logging information about the matched packets in a flow;
redirecting the flow.

At operation 416, the network device (control plane) can program the generated flow-specific rule in the TCAM of the network device. In some embodiments, the flow-specific rule can be programmed in the TCAM at a higher priority than the snoop rule.

Programming the flow-specific rule with higher priority than the snoop rule avoids multiple hits on the snoop rule for certain packets that match the snoop rule in network traffic received subsequent to programming the flow-specific rule. As understood by persons of ordinary skill, rules in a TCAM are prioritized to determine which rule takes precedence when multiple matches occur. When multiple rules match, the TCAM will output the rule having the highest priority. In some implementations, a TCAM can be viewed as a table of entries, and priority of rules in the TCAM can be established by where in the table the rules are stored.

Referring to FIG. 3A, for example, transferring a large data block 302 using RDMA can result in several RDMA messages 306, msg-A, msg-B, msg-C. The first packet in each message is a beginning-of-message packet (i.e., the opcode in the BTH header opcode is RDMA_WRITE_FIRST), which triggers the snoop rule. While a flow-specific rule is created after learning the flow from the beginning-of-message packet in the first message (e.g., in msg-A), the beginning-of-message packets (Pᵢ and Pⱼ) in subsequent messages (msg-B, msg-C) still match the snoop rule. This leads to these packets being sent to the CPU only to be discarded, wasting CPU resources since the flow is already known. To avoid snooping and processing beginning-of-message packets for flows that have already been learned, the flow-specific rule is programmed into the TCAM with a higher priority than the priority of the snoop rule. This ensures that the beginning-of-message packet in messages subsequent to the first message will match the flow-specific rule instead of the snoop rule, thus preventing redundant packet delivery to the CPU.

Processing of the snooped packet by the CPU can be deemed complete.

It can be appreciated from the above that identifying flows based on their beginning-of-message packets, instead of randomly sampling traffic, offers two key advantages: it lowers CPU processing overhead for flow identification and increases the reliability of discovering new flows.

### Message Markers

The above BTH opcode used in the snoop rule represents an example of a “message marker.” A message marker, in accordance with the present disclosure, is information in a packet that serves to identify the occurrence an RDMA message, allowing for a packet in the message to be snooped so that the flow associated with the RDMA message can be identified from the snooped packet. In the disclosed examples of RoCE v2 messages, the message marker can be one of the BTH opcodes noted above, namely RDMA_WRITE_FIRST, RDMA_READ_FIRST, or RDMA_SEND_FIRST. It will be appreciated that the BTH opcode can be RDMA_WRITE_LAST, RDMA_READ_LAST, or RDMA_SEND_LAST, as well. More generally, a message marker in accordance with the present disclosure can be any information contained in a packet that indicates the occurrence of an RDMA message. The message marker can occur in a packet anywhere in the message, and is not necessarily the first packet or the last packet in the message.

Further in accordance with the present disclosure, the number of packets that a message marker occurs in is uncorrelated with the number of packets in a given RDMA message. In other words, the message marker occurs in less than all the packets of the given RDMA message. In the example of RoCE v2, for instance, the BTH opcode RDMA_WRITE_FIRST occurs only once in a given RoCE v2 message, namely in the first packet of the message, irrespective of how many packets are in the given message. In various embodiments, the message marker used to identify an RDMA message may occur in multiple packets in the message, but in fewer than all of the packets in the message, and as a result avoids hitting the snoop rule too many times. This aspect of a message marker improves learning of RDMA flows by avoiding every packet in the message being snooped, which scales well with the number of packets in a message; the flow can be identified by snooping only one packet in an RDMA message irrespective of the number of packets in that message.

Further in accordance with the present disclosure, a message marker can occur in any of the constituent packets in an RDMA message. In the example of RoCE v2, for instance, the BTH opcode RDMA_WRITE_FIRST occurs in the first packet of a RoCE v2 message. However, in RDMA messages in general, the packet that contain the message marker may appear anywhere in the stream of packets that constitute the message.

### Redirecting Identified Flows

Another aspect of the present disclosure is directed to cluster load balancing (CLB) in a distributed computing system (e.g., 100, FIGS. 1, 200, FIG. 2). Merely for discussion purposes, the leaf-spine network topology in FIG. 2 will be used as an illustrative example of a distributed computing system to describe load distribution across clusters of GPUs 24 hosted on servers 22.

As shown in the example in FIG. 2, each leaf device 206 is connected to each of the spine devices 204, allowing a GPU 24 in a server 22 connected to a leaf device to reach any GPU in any other server on any other leaf device via any one of the spine devices. It is noted that when the source and destination servers are connected to the same leaf device, the traffic is forwarded by the leaf device itself without sending the traffic to a spine device.

Each leaf device 206 may load-balance remote traffic (i.e., traffic destined to other leaf devices) across the spine devices 204 to avoid oversubscribing any one link to a spine device. This load-balancing will also affect utilization of the links from the spine devices back to the leaf. In some embodiments, the leaf device may use load balancing mechanisms such as static ECMP hashing, dynamic load balancing (DLB), etc. to distribute traffic across spine devices.

ECMP is a configuration whereby a network device has multiple equivalent next hops that a packet can be forwarded to. The network device forwards the packet on a link (interface) selected from among the links to which the multiple equivalent next hops are connected. There are two common ways to select the link. The first is to compute a hash (static ECMP hash) from the data in the packet and use the computed hash value to select the link to the next hop. An alternative way of selecting the link is a load balancing technique, sometimes referred to as DLB, which chooses the link based on which link currently has the lowest load.

In the leaf-spine topology in FIG. 2, for example, each leaf device 206 in the network has multiple nexthops (e.g., spine devices 204) to which a packet can be forwarded to reach a destination. In addition, the link (path) between a given leaf device (e.g., ToR 1) and a given spine device (e.g., spine 1) may itself comprise multiple connections, for example, as in the case of link aggregation technologies such as link aggregation groups (LAG), multi-chassis link aggregation (MLAG), and so on.

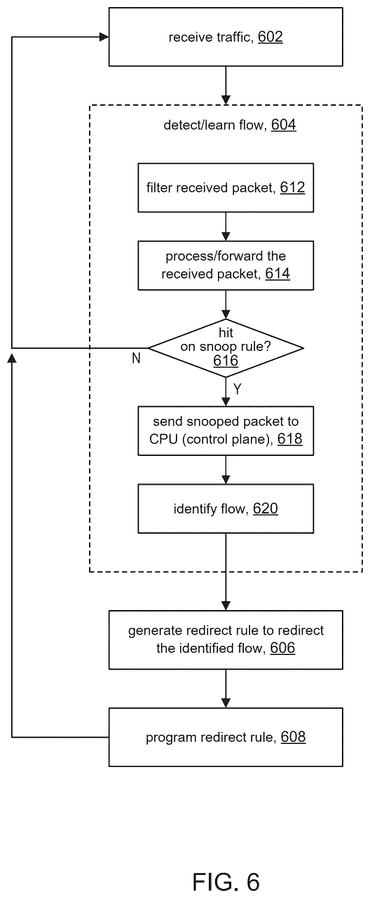

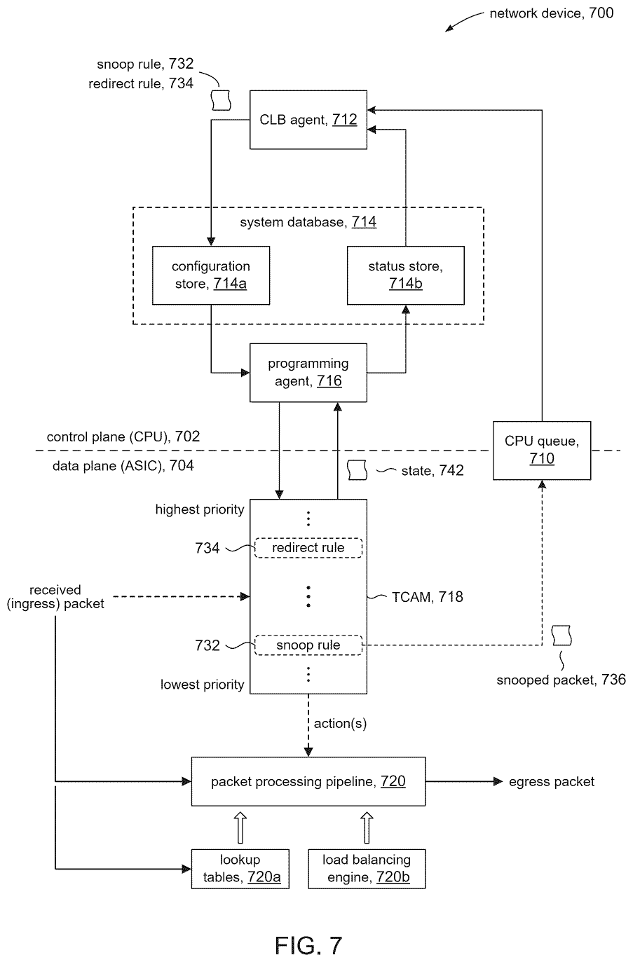

FIGS. 6 and 7 illustrate a high-level example of processing packets in a network device to redirect flows in accordance with the present disclosure. The operations will be described in the context of the distributed computing system shown in FIG. 2, comprising a leaf-spine configuration, with the understanding that the present disclosure is applicable to other distributed computing system topologies. For discussion purposes, leaf device ToR 1 in FIG. 2 will be used as the example network device. The operations will be explained using RoCE v2 protocol (e.g., FIGS. 3A and 3B) as an illustrative example protocol. It will be understood that the present disclosure is applicable using other data transfer protocols where the transfer of a data block can be transferred using multiple delineated messages.

The processing is divided between the control plane and the data plane. In some embodiments, the network device can include one or more processing units (circuits), which when operated, can cause the network device to perform processing in accordance with FIG. 6. Processing units (circuits) in the control plane, for example, can include general CPUs that operate by way of executing computer program code stored on a non-volatile computer readable storage medium (e.g., read-only memory); e.g., CPU 702 (FIG. 7) in the control plane can be a general CPU. Processing units (circuits) in the data plane can include specialized processors such as digital signal processors, field programmable gate arrays, application specific integrated circuits (ASICs), and the like, that operate by way of executing computer program code or by way of logic circuits being configured for specific operations; e.g., switching ASIC 704 in the data plane.

At operation 602, the network device (e.g., ToR 1) can receive network traffic. For example, ToR 1 can receive traffic (packets) from a GPU 24 on a server 22 connected to ToR 1 and destined to another GPU in the network.

At operation 604, the network device can detect/learn a flow in the received traffic. More specifically, in accordance with the present disclosure, the network device can detect/learn new remote flows. A remote flow is a flow that is destined to a GPU on a network device (e.g., ToR 2) different from the network device that the source GPU is on (e.g., ToR 1). Here, ToR 1 can be referred to as the local device and ToR 2 is the remote device. In accordance with the present disclosure, a remote flow is deemed to be “new” in that the flow is not currently being redirected (operations 606/608).

In various embodiments, a new remote flow can be learned from an external source separate from the network device; for example:
In some embodiments, a new RoCE v2 flow can be explicitly identified by a user who enters the specific parameters of the flow (flow parameters), for example, via a CLI on the network device. Parameters of the flow, which can be referred to collectively as the flow key, can include:
   IpProto==UDP to look for UDP packets
   L4DstPort==4791 to look for RoCE v2 type UDP packets
   DstIP==IP (v4 or v6) address of destination IP contained the received packet
   QPairId==DstQPairId (FIG. 3B) contained in the BTH header in the received packet
In some embodiments, RoCE v2 flows can be detected by a network management system, a test access point device, or other packet sniffing device, which can then inform the network device.
In some embodiments, the host application stack can export the flows it is using to the network device.

In some embodiments, a snoop rule can be used to detect RoCE v2 flows, and in particular the beginning of a RoCE v2 message. Flows can be detected by first programming a snoop rule (e.g., 732) in TCAM 718. In some embodiments, for example, the snoop rule can be a predefined rule that is to be programmed via the CLB agent 412 as part of initializing the network device. In some embodiments, the snoop rule can be programmed by a user (not shown) via a suitable CLI (command line interface). Using RoCE v2 packets as an example, the snoop rule can match on RoCE v2 packets and more specifically RoCE v2 packets that indicate the beginning of a message. In some embodiments, the match criteria for a snoop rule can match on the following data fields in a RoCE v2 packet to identify a beginning-of-message packet:
IpType—The match criteria can match on this data field to look for IPv4 or IPv6 packets.
IpProto—RoCE v2 is encapsulated in a UDP payload. Accordingly, the match criteria can match on this data field to identify packets that encapsulate UDP.
L4DstPort—RoCE v2 uses a destination port number of 4791. Accordingly, the match criteria can match on this data field having the value 4791.
BTH opcode—As described above, the beginning of an RoCE v2 message is indicated by the first packet in the message having one of the beginning-of-message opcodes listed above. The match criteria can match on this data field to contain one such opcode, for example RDMA_WRITE_FIRST, RDMA_READ_FIRST, or RDMA_SEND_FIRST. More generally however, in other embodiments, the snoop rule can match on other data field(s) that indicate the packet is the first packet in a message.

In accordance with the present disclosure, the snoop rule can be further configured to snoop specifically for remote RoCE v2 traffic. In some embodiments, the match criteria can include criteria to look for remote traffic, such as:
DstClassL2—In the case of a bridged VxLAN (virtual extensible local area network) configuration, this data field is used to match on packets that egress with a VxLAN encapsulation by matching on the ClassId of the remote MAC.
DstL3EgressNextHop—In the case of routed forwarding, in some embodiments, the egress nexthop can be encoded so that all ECMP groups have bit 0x8000 set. Because local servers are not reached via an ECMP group, matching on only this bit in this data field will allow filtering of only remote flows.
FecId—In the case of ECMP-based forwarding, for example, ECMP FECs can be between 0x0000 and 0x10000. Because local servers are not reached via an ECMP group, matching on only this bit in this data field will allow filtering of only remote flows.

As explained above, in the case of encapsulated flows, e.g., tunneled flows such as VxLAN tunnels, the data fields (e.g., headers) for identifying a beginning-of-message packet will occur in different locations within the packet depending on the particular encapsulation. It will be appreciated that the match criteria in the snoop rule can be specified accordingly to accommodate the different encapsulations.

In some embodiments, operation 604 for detecting flows using snoop rule 732 programmed in TCAM 718 can proceed as follows:
At operation 612, the network device filters packets in the traffic received at operation 602. Each packet is input to the TCAM 718 to match against rules stored in the TCAM, including the snoop rule 732.
At operation 614, the network device can provided the received packet to a packet processing pipeline (e.g., 720). The packet processing pipeline can process the received packet according to lookup tables (e.g., 720a) to rewrite the received packet for egress; e.g., identifying a next hop, encapsulating the packet, changing data fields in the packet, updating packet metadata (e.g., counters) associated with the packet, dropping the packet, and so on. Processing in the pipeline can also be controlled by action(s) associated with a matched rule (if any) from the TCAM.
The packet processing pipeline can include a default load balancing engine 720b to distribute egress packets across next hop devices (e.g., spine devices 204) that can reach the destination. In some embodiments, for example, the load balancing engine can be based on an ECMP mechanism that uses static hashing to select a target spine device on which to forward a given ingress packet. In some embodiments, the ECMP mechanism can include a distributed load balancing (DLB) component.
Processing in the pipeline can include accessing the lookup tables to rewrite the received packet for egress; e.g., additional encapsulations, changing data fields in the packet, etc. The TCAM action(s) can also control the pipeline in terms of rewriting the packet, updating packet metadata (e.g., counters) associated with the packet, dropping the packet, and so on.
At decision point 616, if the snoop rule 732 does not match the received packet, the received packet requires no further processing, and the network device returns to operation 604 to resume receiving traffic. On the other hand, if the received packet matched (hit) on the snoop rule, the packet is snooped and processing can proceed with operation 618.
At operation 618, the snooped packet can be sent to the CPU for processing. In some embodiments, for example, the snoop rule 732 can include an action that causes the network device to enqueue the snooped packet 736 on a CPU queue 710 that serves as an interface between ASIC 704 and CPU 702. CLB agent 712 running on the CPU can process the snooped packet.
At operation 620, the CLB agent 712 can determine the flow key that identifies the flow using the snooped packet. In the case of RoCE v2 packets, for example, the flow key can be a 3-tuple comprising the source and destination IP addresses in the IP header portion of the snooped packet and the destination QPairId in the BTH header (FIG. 3B) of the snooped packet.

At operation 606, a CLB agent (e.g., 712, FIG. 7) running on CPU 702 of the network device generates redirect rule 734 to handle a newly identified flow from operation 604. In a leaf-spine network, like the one in FIG. 2, each leaf device 206 has multiple paths that connect to every spine device 204. This topology provides multiple paths for traffic between leaf devices (e.g., ToR 1 to ToR 2). Traffic from a leaf device can be sent to any spine device, which acts as the next hop, to reach another leaf device. This allows for load balancing across spine devices, preventing any single device from being over-subscribed.

In accordance with the present disclosure, the CLB agent 712 selects/identifies a “target” spine device as the next hop for the new flow. This selection can be based on various mechanisms and criteria. In some embodiments, for example, next hop selection can be based on techniques disclosed in commonly owned U.S. application Ser. No. 18/902,521, filed Sep. 30, 2024, entitled “Systems And Methods For Reducing Congestion In Transmitting Flows Of Communication Collectives,” which is incorporated herein by reference for all purposes. In other embodiments, a round-robin approach can be used, assigning flows in a repeating sequence (e.g., spine 1, spine 2, . . . , spine N, then back to spine 1). In still other embodiments, the CLB agent can monitor the traffic load on each spine device (including existing flows and other network traffic) and assign the new flow to the device with the lowest current load.

The CLB agent 712 can generate a redirect rule 734 comprising a match component and an action component. The match component can include criteria to match the flow, and the action component can comprise action(s) to redirect a matched packet to the selected spine device as the next hop. The match component can comprise the following criteria:
IpProto==UDP to look for UDP packets
L4DstPort==4791 to look for RoCE v2 type UDP packets
DstIP==IP (v4 or v6) address of destination IP contained the received packet
QPairId==DstQPairId (FIG. 3B) contained in the BTH header in the received packet.
   As noted above, in the case of encapsulated flows, e.g., tunneled flows such as VxLAN tunnels, the data fields (e.g., headers) for a flow will occur in different locations within the packet depending on the particular encapsulation. It will be appreciated that the match criteria in the redirect rule can be specified accordingly to look for these data fields depending on the different encapsulations.

The action component can comprise:
ECMP cancel—this informs the network device to bypass ECMP processing. Referring to FIG. 2, for example, the set of links from a leaf device to the spines can define an ECMP group, where a link from leaf to spine is selected using ECMP. This action cancels selecting the link using ECMP.
Redirect=portNum—this informs the network device to egress (redirect) the packets on the specified port, which in the context of the present disclosure, is the port to which the selected spine device is connected.
Redirect=new next hop—this informs the network device to egress the packet on a different nexthop index. This index will contain both the egress port to send the packet to and any packet rewrites that need to happen to the packet.
In some embodiments, the redirect rule may include additional actions, for example, increment counters.

In some embodiments, the CLB agent 712 can store the generated redirect rule 734 in a system database 714, comprising a configuration store 714a and a status store 714b, that provides communication between the programming agent and the CLB agent. The CLB agent can store the generated redirect rule in the configuration store 714a.

At operation 608, a programming agent (e.g., 716, FIG. 7) running on CPU 702 of the network device can program the redirect rule 734 in a forwarding information base (e.g., TCAM 718) of the network device. In some embodiments, for example, the programming agent 716 can be triggered when the redirect rule is stored in configuration store 714a; e.g., a signal can be sent to the programming agent, the programming agent can poll the configuration store, etc.

In some embodiments, the redirect rule can be programmed in the TCAM at a higher priority than the snoop rule. Programming the redirect rule with higher priority than the snoop rule avoids multiple hits on the snoop rule for network traffic received subsequent to programming the redirect rule. Referring to FIG. 3A, for example, transferring a large data block 302 using RDMA can result in several RDMA messages 306, msg-A, msg-B, msg-C. The first packet in each message is a beginning-of-message packet (i.e., the opcode in the BTH header opcode is RDMA_WRITE_FIRST), which triggers the snoop rule. Although a redirect rule is created after learning the flow from the beginning-of-message packet in the first message (e.g., in msg-A), the beginning-of-message packets (Pᵢ and Pⱼ) in subsequent messages (msg-B, msg-C) will still match the snoop rule. This leads to these packets being sent to the CPU only to be discarded, wasting CPU resources since the flow is already known. To avoid this, the redirect rule is programmed into the TCAM with a higher priority than the priority of the snoop rule. This ensures that the beginning-of-message packet in messages after the first message will match the redirect rule instead of the snoop rule, thus preventing redundant packet delivery to the CPU.

It is further noted, because TCAM works by highest priority match, if the redirect rule is programmed at a lower priority than the snooped rule, then the redirect action will never take place.

Processing of the snooped packet by the CPU can be deemed complete. Processing can return to operation 602 to continue receiving and processing traffic.

In accordance with the present disclosure, when a flow is detected between a source (e.g., GPU 1-1-1 on ToR 1) and a destination (e.g., GPU 2-Y-1 on ToR 2), the flow is assigned, or pinned, to a particular spine device. Subsequently, all packets belonging to that flow are forwarded through the designated spine device to reach the destination GPU. In AI/ML applications, for example, communication between GPUs often involves numerous flows, each containing multiple messages. Flow redirection in accordance with the present disclosure allows for independent assignment of each flow to a spine device, providing finer-grained traffic distribution across the spine layer compared to traditional load balancing methods like static ECMP hashing. This more even distribution of traffic between source and destination devices helps to optimize network utilization.

### Ageing Out Redirect Rule

Referring to FIG. 7, the programmed redirect rule 734 can be aged out (deleted) in order to accommodate the limited capacity of the TCAM 718. In some embodiments, for example, the TCAM can provide state information 742 (e.g., port state, TCAM state, etc.) to the programming agent 716. The state information 742 can include data that represents the state of the TCAM; e.g., number of rules, which rules were hit, etc. The state information 742 can include a hit bit that is set when an entry is matched, or a counter value that is incremented when an entry is matched. In case of a hit bit, the hit bit is cleared at a time T0. If the hit bit is still cleared at time T1 (T0+aging timer) then the entry will be deemed to have aged out. In the case of a counter, the counter can be handled in a manner similar to that of the hit bit, namely by clearing the counter on every read. If the counter is still cleared after expiration of an aging timer, then the entry will be deemed to have timed out.

### Illustrative Sequence

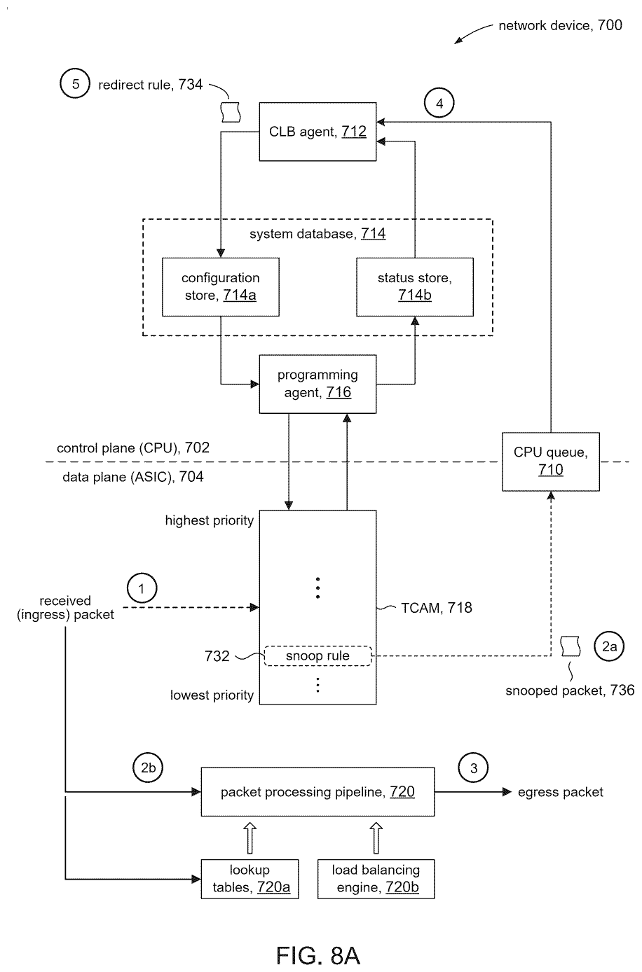

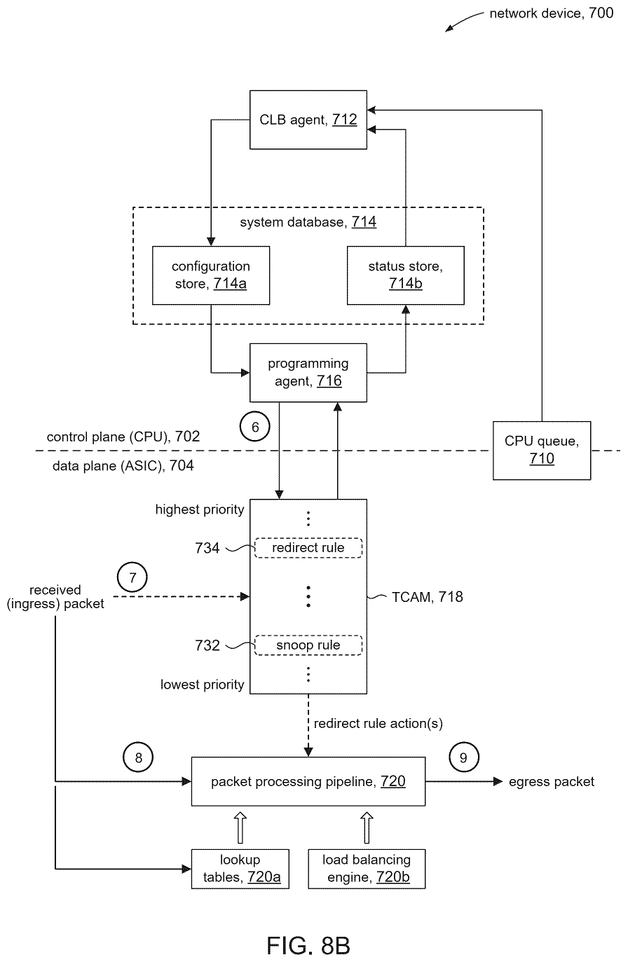

FIGS. 8A and 8B illustrate an example of a sequence for redirecting flows in accordance with the present disclosure. FIG. 8A illustrates a learn sequence for learning a flow. The circled numbers are time indices:
Time index 1—A packet is received and matched against rules in TCAM 718. For discussion purposes, suppose the received packet is a RoCE v2 beginning-of-message packet for an unlearned flow. The received packet will match on the snoop rule 432 because it is a beginning-of-message packet (i.e., the BTH opcode is RDMA_WRITE_FIRST).
Time index 2a and time index 2b—The action component of the snoop rule causes the network device to enqueue the snooped packet 736 on the CPU queue 710 (time index 2a), while at the same time (time index 2b) the network device passes the received packet to the packet processing pipeline 720, where the packet is processed.
Time index 3—The packet processing pipeline can process the received packet for egress, including performing load balancing on the packet, using for example a suitable static ECMP hash algorithm to select the next hop to which the received packet is forwarded.
Time index 4—The CLB agent dequeues the snooped packet and determines that the packet is the beginning (the first packet) of a RoCE v2 message (detected message). In response, the CLB agent identifies one of the spine devices (target spine device) to which packets in the detected message will be sent. The CLB agent can select the target spine device using a round-robin schedule, the target spine device can be selected based on current loading on each spine device, and in general the target spine device can be selected using any suitable selection criteria.
Time index 5—The CLB agent generates a TCAM rule (redirect rule 734) to match on packets that constitute the detected flow and cause (redirect) such packets to the target spine device. The match criteria for the redirect rule can be obtained from the snooped packet. For example, the generated redirect rule can have the following match criteria:
   IpProto=UDP—looks for UDP protocols
   L4DstPort=4791—indicates the ingress packet is a RoCE v2 packet
DstIP—this is set to the IP address of the GPU that is the destination of the detected message
QPairId—The destination GPU can process multiple different messages. QPairId identifies a specific message to the destination GPU. There can be multiple messages between the source GPU and the destination GPU, and this Id identifies each such message.

FIG. 8B illustrates programming a redirect rule to redirect a learned flow and an example of a sequence after the redirect rule has been programmed:
Time index 6—The platform agent 716 programs the redirect rule 734 in the TCAM at a higher priority in the TCAM than the snoop rule 732 so that if an ingress packet matches on both the snoop rule and the redirect rule, the TCAM will produce the redirect rule and the packet will be processed according to the action component in the redirect rule.
Time index 7—After the redirect rule is programmed, a RoCE v2 packet is received that matches the redirect rule. For example, the packet will match the redirect rule if the packet contains:
   IpProto=UDP—the packet is a UDP protocol
   L4DstPort=4791—the ingress packet is a RoCE v2 packet
   DstIP—the IP address of the GPU that is the destination of the detected message
   QPairId-QPairId identifies a specific message to the destination GPU.
Time index 8 and time index 9—The packet will be input to the pipeline (time index 8) and the action(s) associated with the redirect rule output by the TCAM will cause the pipeline to forward the packet according to the next hop (destination) information in the redirect rule, instead of using the load balancing engine 720b (time index 9) to select the next hop. In other words, the received packet is forwarded to the next hop indicated in the action in the redirect rule.

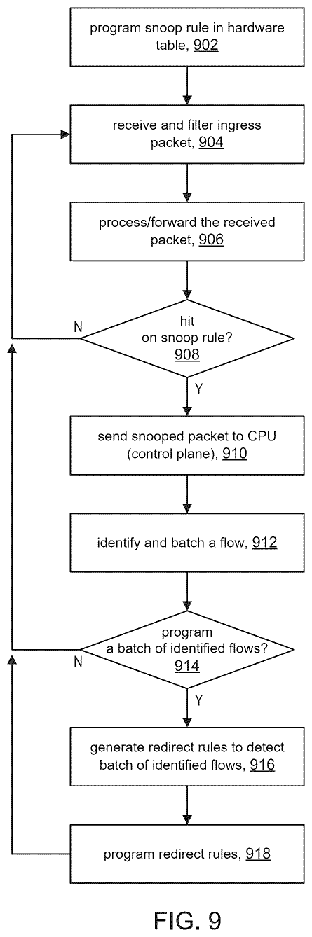

FIG. 9, and with reference to FIG. 7, illustrate a high-level example of processing packets in a network device to redirect flows in another embodiment in accordance with the present disclosure. The operations will be described in the context of the distributed computing system shown in FIG. 2, comprising a leaf-spine configuration, with the understanding that the present disclosure is applicable to other distributed computing system topologies. For discussion purposes, leaf device ToR 1 in FIG. 2 will be used as the example network device. The operations will be explained using RoCE v2 protocol (e.g., FIGS. 3A and 3B) as an illustrative example protocol. It will be understood that the present disclosure is applicable to other types of data transfer using protocols or hardware where the start and the end of the data transfer is delineated.

At operation 902, the network device can program a snoop (learning) rule to learn flows in accordance with the present disclosure. In some embodiments, for example, the snoop rule can be a predefined rule that is to be programmed via the CLB agent 412 as part of initializing the network device. In some embodiments, the snoop rule can be programmed by a user via a suitable CLI. Using RoCE v2 packets as an example, the snoop rule can match on RoCE v2 packets and more specifically RoCE v2 packets that indicate the beginning of a message. In some embodiments, the match criteria for a snoop rule can match on the following data fields in a RoCE v2 packet to identify a beginning of message packet:
IpType—The match criteria can match on this data field to look for IPv4 or IPv6 packets.
IpProto—RoCE v2 is encapsulated in a UDP payload. Accordingly, the match criteria can match on this data field to identify packets that encapsulate UDP.
L4DstPort—RoCE v2 uses a destination port number of 4791. Accordingly, the match criteria can match on this data field having the value 4791.
BTH opcode—As described above, the beginning of an RoCE v2 message is indicated by the first packet in the message having one of the beginning-of-message opcodes listed above. The match criteria can match on this data field to contain one such opcode, for example RDMA_WRITE_FIRST, RDMA_READ_FIRST, or RDMA_SEND_FIRST. More generally however, in other embodiments, the snoop rule can match on other data field(s) that indicate the packet is the first packet in a message.

In some embodiments, the match criteria of the snoop rule can include matching on the ingress interface (source I/F) that the packet ingressed on. The ingress I/F is metadata that indicates the interface that a packet ingresses on.

The above match criteria will match RoCE v2 packets that are on a local flow or a remote flow. A local flow refers to a flow between servers connected to the same network device. Referring to FIG. 2, for example, a flow from server 2-1 to server 2-Y represents a local flow because both servers are connected to the same leaf device (ToR 2) ; i.e., server 2-Y is local relative to server 2-1. Likewise, a flow between GPU 2-1-1 to GPU 2-1-2 represents a local flow because both GPUs are on ToR 2. On the other hand, a flow from server 1-1 on ToR 1 to server 2-Y on ToR 2 represents a remote flow because the servers are on different ToRs (network devices); i.e., server 2-Y is remote relative to server 1-1.

In accordance with the present disclosure, the snoop rule can be further configured to snoop specifically for remote RoCE v2 traffic. In some embodiments, the match criteria can include criteria to look for remote traffic, such as:
DstClassL2—In the case of a bridged VxLAN (virtual extensible local area network) configuration, this data field is used to match on packets that egress with a VxLAN encapsulation by matching on the ClassId of the remote MAC.
DstL3EgressNextHop—In the case of routed forwarding, in some embodiments, the egress nexthop can be encoded so that all ECMP groups have bit 0x8000 set. Because local servers are not reached via an ECMP group, matching on only this bit in this data field will allow filtering of only remote flows.
FecId—In the case of ECMP-based forwarding, for example, ECMP FECs can be between 0x0000 and 0x10000. Because local servers are not reached via an ECMP group, matching on only this bit in this data field will allow filtering of only remote flows.
   As explained above, in the case of encapsulated flows, e.g., tunneled flows such as VxLAN tunnels, the data fields (e.g., headers) for identifying a beginning-of-message packet will occur in different locations within the packet depending on the particular encapsulation. It will be appreciated that the match criteria in the snoop rule can be specified accordingly to accommodate the different encapsulations.

At operation 904, the network device (e.g., ToR 1) can receive network traffic. For example, ToR 1 can receive traffic (packets) from a GPU 24 on a server 22 connected to ToR 1 and destined to another GPU in the network. Each packet is input to the TCAM 718 to match against rules stored in the TCAM, including the snoop rule 732.

At operation 906, the network device can process the received packet in a packet processing pipeline (e.g., 720). The packet processing pipeline can process/forward the received packet according to lookup tables (e.g., 720a), including any action(s) associated with a matched rule from the TCAM.

The packet processing pipeline can include a load balancing engine 720b to distribute egress packets across next hop devices (e.g., spine devices 204) that can reach the destination. In some embodiments, for example, the load balancing engine can use static ECMP hashing to select a target spine device on which to forward a given ingress packet.

Processing in the pipeline can include accessing the lookup tables to rewrite the received packet for egress; e.g., additional encapsulations, changing data fields in the packet, etc. The TCAM action(s) can also include rewriting the packet, updating packet metadata (e.g., counters) associated with the packet, the packet may be dropped, and so on.

At decision point 908, if the received packet does not match the snoop rule 732, the received packet requires no further processing. The network device returns to operation 504 to resume receiving traffic. On the other hand, if the received packet matched (hit) on the snoop rule, then processing can proceed with operation 910.

At operation 910, the snooped packet can be sent to the CPU for processing. In some embodiments, for example, the snoop rule 732 can include an action that causes the network device to enqueue the snooped packet 736 on a CPU queue 710 that serves as an interface between ASIC 704 and CPU 702. CLB agent 712 running on the CPU can process the snooped packet.

At operation 912, the CLB agent can identify and batch a flow in response to the snooped packet. In some embodiments, for example, the CLB agent 712 can identify the flow from the snooped packet. In the case of RoCE v2 packets, the flow can be defined by a 3-tuple comprising the source and destination IP addresses in the IP header portion of the packet and the destination QPairId in the BTH header (FIG. 3B). In accordance with the present disclosure, the CLB can collect a list (batch) of identified flows to be processed at one time, as opposed to processing each flow one at a time.

At decision point 914, the batch of identified flows collected at operation 912 can be processed in response to a trigger. In some embodiments, the trigger can be the expiration of a time (e.g., every 0.5 seconds), the trigger can be based on the number of flows in the batch, and so on. If the trigger occurs, then processing can continue to operation 914; otherwise, processing can return to operation 904 to continue receiving network traffic.

At operation 916, a CLB agent (e.g., 712, FIG. 7) running on CPU 702 of the network device generates redirect rule 734 to handle a newly identified flow from operation 604. In a leaf-spine network, like the one in FIG. 2, each leaf device 206 connects to every spine device 204. This topology provides multiple paths for traffic between leaf devices (e.g., ToR 1 to ToR 2). Traffic from a leaf device can be sent to any spine device, which acts as the next hop, to reach another leaf device. This allows for load balancing across spine devices, preventing any single device from being over-subscribed.

In accordance with the present disclosure, the CLB agent 712 selects/identifies a “target” spine device as the next hop for the new flow. This selection can be based on various mechanisms and criteria. For example, a round-robin approach can be used, assigning flows in a repeating sequence (e.g., spine 1, spine 2, . . . , spine N, then back to spine 1). Alternatively, the CLB agent can monitor the traffic load on each spine device (including existing flows and other network traffic) and assign the new flow to the device with the lowest current load.

The CLB agent 712 can generate a redirect rule 734 comprising a match component and an action component. The match component can include criteria to match the flow, and the action component can comprise action(s) to redirect a matched packet to the selected spine device as the next hop. The match component can comprise the following criteria:
IpProto==UDP to look for UDP packets
L4DstPort==4791 to look for RoCE v2 type UDP packets
DstIP==IP (v4 or v6) address of destination IP contained the received packet
QPairId==DstQPairId (FIG. 3B) contained in the BTH header in the received packet
   As noted above, in the case of encapsulated flows, e.g., tunneled flows such as VxLAN tunnels, the data fields (e.g., headers) for a flow will occur in different locations within the packet depending on the particular encapsulation. It will be appreciated that the match criteria in the redirect rule can be specified accordingly to look for these data fields depending on the different encapsulations.

In some embodiments, the match criteria of the redirect rule can include matching on the ingress interface (source I/F) that the packet ingressed on. The ingress I/F is metadata that indicates the interface that a packet ingresses on.

The action component can comprise:
ECMP cancel—this informs the network device to bypass ECMP processing. Referring to FIG. 2, for example, the set of links from a leaf device to the spines can define an ECMP group, where a link from leaf to spine is selected using ECMP. This action cancels selecting the link using ECMP.
Redirect=portNum—this informs the network device to egress (redirect) the packets on the specified port, which in the context of the present disclosure, is the port to which the selected spine device is connected.
Redirect=new nexthop. This informs the network device to egress the packet on a different nexthop index. This index will contain both the egress port to send the packet to and any packet rewrites that need to happen to the packet.
In some embodiments, the redirect rule may include additional actions, for example, increment counters.

In some embodiments, the CLB agent 712 can store the generated redirect rule 734 in a system database 714, comprising a configuration store 714a and a status store 714b, that provides communication between the programming agent and the CLB agent. The CLB agent can store the generated redirect rule in the configuration store 714a.

At operation 918, a programming agent (e.g., 716, FIG. 7) running on CPU 702 of the network device can program the generated redirect rules 734 in TCAM 718. In some embodiments, for example, the programming agent 716 can be triggered when the redirect rule is stored in configuration store 714a; e.g., a signal can be sent to the programming agent, the programming agent can poll the configuration store, etc. As explained above, in some embodiments, the redirect rule can be programmed in the TCAM at a higher priority than the snoop rule to avoid snooping and processing beginning-of-message packets for flows that have already been learned.

In some embodiments, the CLB agent can specify a “next hop group” that specifies a reference or a pointer to a block of forwarding information associated with the selected target spine device. The forwarding information provides the programming agent with the necessary details to modify packets for proper forwarding to the selected spine. For instance, this information can include specific Ethernet destination addresses, required headers, or MPLS labels. Utilizing a next hop group can be beneficial when the rewrite process is intricate, as it shifts the burden of managing these details from the CLB agent to the programming agent.

Processing can return to operation 904 to continue receiving network traffic.

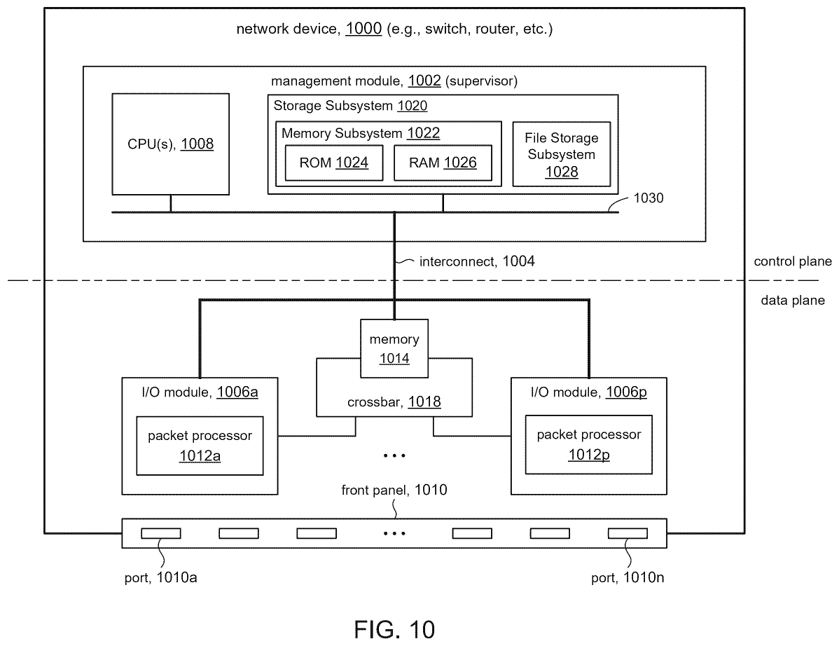

FIG. 10 is a generalized representation of an example network device 1000 (e.g., a router, switch, firewall, and the like) that can be adapted in accordance with the present disclosure. In some embodiments, for example, network device 1000 can include one or more management modules 1002, one or more I/O modules (switches, switch chips) 1006a-1006p, and a front panel 1010 of I/O ports (physical interfaces, I/Fs) 1010a-1010n. Management module 1002 can constitute the control plane of network device 1000 (also referred to as the control layer or simply the central processing unit, CPU), and can include CPU(s) 1008 for managing and controlling operation of network device 1000 in accordance with the present disclosure. CPU(s) 1008 can be a general-purpose processor, such as an Intel®/AMD® x86, ARM® microprocessor and the like, that operates under the control of software stored in a memory device/chips such as read-only memory (ROM) 1024 or random-access memory (RAM) 1026. The control plane provides services that include traffic management functions such as routing, security, load balancing, analysis, and the like.

CPU(s) 1008 can communicate with storage subsystem 1020 via bus subsystem 1030. Other subsystems, such as a network interface subsystem (not shown in FIG. 10), may be on bus subsystem 1030. Storage subsystem 1020 can include memory subsystem 1022 and file/disk storage subsystem 1028. Memory subsystem 1022 and file/disk storage subsystem 1028 represent examples of non-transitory computer-readable storage devices that can store program code and/or data, which when executed by CPU(s) 1008, can cause CPU(s) 1008 to perform operations in accordance with embodiments of the present disclosure.

Memory subsystem 1022 can include a number of memories such as main RAM 1026 (e.g., static RAM, dynamic RAM, etc.) for storage of instructions and data during program execution, and ROM (read-only memory) 1024 on which fixed instructions and data can be stored. File storage subsystem 1028 can provide persistent (i.e., non-volatile) storage for program and data files, and can include storage technologies such as solid-state drive and/or other types of storage media known in the art.

CPU(s) 1008 can run a network operating system stored in storage subsystem 1020. A network operating system is a specialized operating system for network device 1000. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 1030 can provide a mechanism for the various components and subsystems of management module 1002 to communicate with each other as intended. Although bus subsystem 1030 is shown schematically as a single bus, alternative embodiments of the bus subsystem can utilize multiple buses.

The one or more I/O modules 1006a-1006p can be collectively referred to as the data plane of network device 1000 (also referred to as the data layer, forwarding plane, etc.). Interconnect 1004 represents interconnections between modules in the control plane and modules in the data plane. Interconnect 1004 can be any suitable bus architecture such as Peripheral Component Interconnect Express (PCIe), System Management Bus (SMBus), Inter-Integrated Circuit (I2C), etc.

I/O modules 1006a-1006p can include respective packet processing hardware comprising packet processors 1012a-1012p (collectively 1012) to provide packet processing and forwarding capability. Each I/O module 1006a-1006p can be further configured to communicate over one or more ports 1010a-1010n on the front panel 1010 to receive and forward network traffic. Packet processors 1012 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 1012 can include forwarding lookup hardware such as, for example, but not limited to content addressable memory such as ternary CAMs (TCAMs) and static RAM (SRAM).

Memory hardware 1014 can include buffers used for queueing packets. I/O modules 1006a-1006p can access memory hardware 1014 via crossbar 1018. It is noted that in other embodiments, the memory hardware 1014 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device, the method comprising:
programming a first rule in a forwarding table of the network device to match on a message marker in network traffic, wherein the message marker indicates the occurrence of a Remote Direct Memory Access (RDMA) message in the network traffic, wherein the RDMA message comprises a plurality of packets, wherein the message marker is information that occurs in less that all the packets of the RDMA message;
filtering the network traffic using the first rule programmed in the forwarding table;
identifying a filtered packet in the network traffic that matches the first rule programmed in the forwarding table, wherein the filtered packet is a packet in the RDMA message; and
identifying a flow from the filtered packet.

2. The method of claim 1, wherein the message marker occurs in at most one packet in the RDMA message.

3. The method of claim 1, wherein the message marker indicates a beginning-of-message packet in the RDMA message or an end-of-message packet in the RDMA message.

4. The method of claim 1, wherein the message marker occurs in a packet anywhere in the RDMA message.

5. The method of claim 1, wherein the RDMA message is a RDMA over Converged Ethernet (RoCE v2) message.

6. The method of claim 1, wherein the message marker is uncorrelated with the number of packets in the message.

7. The method of claim 1, further comprising:
generating a second rule comprising: (1) match criteria to match packets on the identified flow and (2) one or more actions;
programming the second rule in the forwarding table of the network device;
receiving network traffic subsequent to programming the second rule; and
using the one or more actions in the second rule to process packets in the subsequently received network traffic that match the second rule.

8. The method of claim 7, wherein programming the second rule in the forwarding table includes programming the second rule in the forwarding table with higher priority than a priority of the first rule.

9. The method of claim 7, wherein the one or more actions in the second rule include:
packet redirection, packet rewriting, information logging, counter incrementing, packet dropping.

10. A network device comprising:
one or more computer processors; and
a computer-readable storage device comprising instructions for controlling the one or more computer processors to:
program a first rule in a forwarding table of the network device to match on a message marker in network traffic, wherein the message marker indicates the occurrence of a Remote Direct Memory Access (RDMA) message in the network traffic, wherein the RDMA message comprises a plurality of packets, wherein the message marker is information that occurs in less that all the packets of the RDMA message;
filter the network traffic using the first rule programmed in the forwarding table;
identify a filtered packet in the network traffic that matches the first rule programmed in the forwarding table, wherein the filtered packet is a packet in the RDMA message; and
identify a flow from the filtered packet.

11. The network device of claim 10, wherein the message marker occurs in at most one packet in the RDMA message.

12. The network device of claim 10, wherein the message marker indicates a beginning-of-message packet in the RDMA message or an end-of-message packet in the RDMA message.

13. The network device of claim 10, wherein the message marker occurs in a packet anywhere in the RDMA message.

14. The network device of claim 10, wherein the RDMA message is a RDMA over Converged Ethernet (RoCE v2) message.

15. The network device of claim 10, wherein the computer-readable storage device further comprises instructions for controlling the one or more computer processors to:
generate a second rule comprising match criteria to match packets on the identified flow; and
program the second rule in the forwarding table of the network device with higher priority than a priority of the first rule,
wherein packets on the identified flow are filtered by the second rule instead of by the first rule.

16. A non-transitory computer-readable storage device in a network device, the non-transitory computer-readable storage device having stored thereon computer executable instructions, which when executed, cause the network device to:
program a first rule in a forwarding table of the network device to match on a message marker in network traffic, wherein the message marker indicates the occurrence of a Remote Direct Memory Access (RDMA) message in the network traffic, wherein the RDMA message comprises a plurality of packets, wherein the message marker is information that occurs in less that all the packets of the RDMA message;
filter the network traffic using the first rule programmed in the forwarding table;
identify a filtered packet in the network traffic that matches the first rule programmed in the forwarding table, wherein the filtered packet is a packet in the RDMA message; and
identify a flow from the filtered packet.

17. The non-transitory computer-readable storage device of claim 16, wherein the message marker occurs in at most one packet in the RDMA message.

18. The non-transitory computer-readable storage device of claim 16, wherein the message marker indicates a beginning-of-message packet in the RDMA message or an end-of-message packet in the RDMA message.

19. The non-transitory computer-readable storage device of claim 16, wherein the RDMA message is a RDMA over Converged Ethernet (RoCE v2) message.

20. The non-transitory computer-readable storage device of claim 16, wherein the computer executable instructions, which when executed, further cause the network device to:
generate a second rule comprising match criteria to match packets on the identified flow; and
program the second rule in the forwarding table of the network device with higher priority than a priority of the first rule.
